(19) United States
(12) Patent Application Publication
(10) Pub. No.: US 2004/0073914 A1
(43) Pub. Date: Apr. 15, 2004

(54) Precision time transfer using television signals

(76) Inventor: James J. Spilker JR., Woodside, CA (US)

Correspondence Address: LAW OFFICE OF RICHARD A. DUNNING, JR., 343 SOQUEL AVENUE, SUITE 311, SANTA CRUZ, CA, 95062, US

(21) Appl. No.: 10/613,919

(22) Filed: Jul. 3, 2003

Related U.S. Application Data
(60) Provisional application No. 60/394,335, filed on Jul. 5, 2002.

(51) Int. Cl. H04N 7/16

(52) U.S. Cl. 725/1

(57) ABSTRACT

An apparatus having a method and computer-readable media thereof comprises a front end adapted to receive a television signal comprising a synchronization signal representing precise timing information derived from a satellite signal; and a synchronization unit adapted to obtain the precise timing information from the television signal, and further adapted to provide a clock correction signal based on the precise timing information.

### CROSS-REFERENCE TO RELATED APPLICATIONS

This application claims the benefit of U.S. Provisional Patent Application Ser. No. 60/394,335, “Precision Time Transfer Using Television Signals,” by James J. Spilker, Jr. , filed Jul. 5, 2002, the disclosure thereof incorporated by reference herein in its entirety.

### BACKGROUND

The present invention relates generally to precision time transfer, and particularly to precision time transfer using television signals.

Precision time is ever more critical as telecommunications data rates increase, and wireless base stations need for time synchronization increases. High speed synchronous bit streams must be passed at common rates so that communications traffic does not pile up like cars on a freeway, and data traffic simply fall on the floor. Thus distribution of a master clock time is extremely important.

At one time, it was thought that the clocks at the thousands of telecommunications switches in the US could obtain timing simply by setting their clocks to the average of all of the incoming clocks from nearby switches without use of a centralized master clock. However that approach is subject to the so-called “sunrise” effect, wherein when the sun rises and heats the cables linking the adjacent switches, their frequency decreases slightly because of the heating. If the user clock frequency is decreased to match the average of the adjacent clocks, and all other switch clocks do likewise, the system is unstable and all clocks will decrease to near zero frequency.

The timing information broadcast by radio station WWV operated by the U.S. National Institute of Standards and Technology (NIST) is a commonly-used time transfer system that is used to synchronize household clocks and even wristwatches. This system broadcasts a narrowband signal from the NIST site in Colorado at relatively low frequencies and with a range that can extend to 2000 miles, and is capable of timing to a fraction of a second. However it is not capable of providing timing down to the tens of nanoseconds level required by modern high speed communications often operating at gigabit per second data rates.

One conventional technique for precision time transfer is Global Positioning System (GPS) time transfer. According to this technique, a GPS control segment uplinks a signal comprising information regarding a master clock, such as the Universal Coordinated Time (UTC) provided by the U.S. Naval Observatory Master Clock, to the GPS satellite constellation, which relays the master clock information to ground stations such as telecommunications switches. However, for precision time distribution, the received master clock information must be corrected for ionospheric delay and other propagation effects upon the GPS signal. These corrections add significant cost to the GPS precision time receivers used to receive the GPS signal. Consequently these GPS receivers cost tens of thousands of dollars. Furthermore, GPS signals are transmitted at very low signal levels and thus require line of sight transmission sometimes unavailable in an urban environment and indoors.

### SUMMARY

In general, in one aspect, the invention features an apparatus comprising a front end adapted to receive a television signal comprising a synchronization signal representing precise timing information derived from a satellite signal; and a synchronization unit adapted to obtain the precise timing information from the television signal, and further adapted to provide a clock correction signal based on the precise timing information.

Particular implementations can include one or more of the following features. The satellite is a global positioning system satellite. Implementations comprise a local clock adapted to generate a precise clock signal based on the clock correction signal provided by the synchronization unit. Implementations comprise an antenna adapted to receive the television signal from a transmitter of the television signal, and further adapted to provide the television signal to the front end; and a clock offset unit adapted to provide an offset signal based on a propagation delay between the transmitter of the television signal and the antenna; wherein the local clock is further adapted to generate the precise clock signal based on the offset signal provided by the clock offset unit. The clock offset unit is further adapted to provide the offset signal based on a tropospheric propagation velocity in the vicinity of the antenna. Implementations comprise a telecommunication switch comprising the apparatus of claim 1. The television signal is selected from the group comprising an American Television Standards Committee (ATSC) digital television signal; an Integrated Services Digital Broadcasting-Terrestrial (ISDB-T) signal; a European Telecommunications Standards Institute (ETSI) Digital Video Broadcasting-Terrestrial (DVB-T) signal; and a National Television System Committee (NTSC), Phase Alternating Line (PAL), or Sequential Color with Memory (SECAM) analog television signal.

In general, in one aspect, the invention features a method and computer-readable media thereof. The method comprises receiving a television signal comprising a synchronization signal representing precise timing information derived from a satellite signal; obtaining the precise timing information from the television signal; and providing a clock correction signal based on the precise timing information.

Particular implementations can include one or more of the following features. The satellite is a global positioning system satellite. Implementations comprise generating a precise clock signal based on the clock correction signal provided by the synchronization unit. Implementations comprise determining a propagation delay between a transmitter of the television signal and an antenna that receives the television signal; and providing the clock correction signal based on the precise timing information and the propagation delay. Determining the propagation delay comprises determining a tropospheric propagation velocity in the vicinity of the antenna. The television signal is selected from the group comprising an American Television Standards Committee (ATSC) digital television signal; an Integrated Services Digital Broadcasting-Terrestrial (ISDB-T) signal; a European Telecommunications Standards Institute (ETSI) Digital Video Broadcasting-Terrestrial (DVB-T) signal; and a National Television System Committee (NTSC), Phase Alternating Line (PAL), or Sequential Color with Memory (SECAM) analog television signal.

In general, in one aspect, the invention features an apparatus comprising a satellite time receiver adapted to receive a satellite signal from a satellite, the satellite signal comprising precise timing information; and a television transmitter adapted to generate a television signal comprising a synchronization signal based on the precise timing information, and further adapted to transmit the television signal.

Particular implementations can include one or more of the following features. The satellite is a global positioning system satellite. The television signal is selected from the group comprising an American Television Standards Committee (ATSC) digital television signal; an Integrated Services Digital Broadcasting-Terrestrial (ISDB-T) signal; a European Telecommunications Standards Institute (ETSI) Digital Video Broadcasting-Terrestrial (DVB-T) signal; and a National Television System Committee (NTSC), Phase Alternating Line (PAL), or Sequential Color with Memory (SECAM) analog television signal.

In general, in one aspect, the invention features a method and computer-readable media thereof. The method comprises receiving a satellite signal from a satellite, the satellite signal comprising precise timing information; generating a television signal comprising a synchronization signal based on the precise timing information; and transmitting the television signal.

Particular implementations can include one or more of the following features. The satellite is a global positioning system satellite. The television signal is selected from the group comprising an American Television Standards Committee (ATSC) digital television signal; an Integrated Services Digital Broadcasting-Terrestrial (ISDB-T) signal; a European Telecommunications Standards Institute (ETSI) Digital Video Broadcasting-Terrestrial (DVB-T) signal; and a National Television System Committee (NTSC), Phase Alternating Line (PAL), or Sequential Color with Memory (SECAM) analog television signal.

The details of one or more implementations are set forth in the accompanying drawings and the description below. Other features will be apparent from the description and drawings, and from the claims.

### DESCRIPTION OF DRAWINGS

FIG. 1 shows a precision time transfer system according to a preferred embodiment.

FIG. 2 shows a process that can be performed by the precision time transfer system of FIG. 1 according to a preferred embodiment.

FIG. 3 is a block diagram of a television station that can act as the television station of FIG. 1.

FIG. 4 shows a process that can be executed by the television station of FIG. 3 according to a preferred embodiment.

FIG. 5 is a block diagram of a television timing receiver that can provide a precise clock signal, for example within the telecommunication switches of FIG. 1.

FIG. 6 shows a process that can be performed by the receiver of FIG. 5 according to a preferred embodiment.

The leading digit(s) of each reference numeral used in this specification indicates the number of the drawing in which the reference numeral first appears.

### DETAILED DESCRIPTION

According to one embodiment of the present invention, a time transfer method uses Global Positioning System (GPS) time transfer to synchronize the master symbol rate clock at a digital or analog television studio. A precision rubidium, cesium, or other stable clock is used to control the symbol clock rate of the television signal. This stable clock is in turn locked to the GPS master clock information. The television signal is then used to carry time to users at fixed locations at previously-surveyed sites. The user need receive only one such television signal.

Eventually most television transmitters could be synchronized in this manner, thereby permitting any broadcast television transmitter to transfer precision time. The time transfer can take place at much lower signal levels than those required for actual television reception because it is only necessary to lock the user clock to the synchronization signal embedded in the digital or analog television signal.

Television signals include components that can be used to convey timing information. Suitable components within the American Television Standards Committee (ATSC) digital television signal include synchronization codes such as the Field Synchronization Segment within an ATSC data frame and the Synchronization Segment within a Data Segment within an ATSC data frame, as described in copending U.S. Non-provisional Patent Application Ser. No. 09/887,158, “Position Location using Broadcast Digital Television Signals,” by James J. Spilker and Matthew Rabinowitz, filed Jun. 21, 2001, the disclosure thereof incorporated by reference herein in its entirety.

Suitable components within the European Telecommunications Standards Institute (ETSI) Digital Video Broadcasting-Terrestrial (DVB-T) and Integrated Services Digital Broadcasting-Terrestrial (ISDB-T) digital television signals include scattered pilot carriers, as described in copending U.S. Non-provisional Patent Applications Ser. No. 09/932,010, “Position Location using Terrestrial Digital Video Broadcast Television Signals,” by James J. Spilker and Matthew Rabinowitz, filed Aug. 17, 2001; and Ser. No. 10/290,984, “Wireless Position Location Using the Japanese ISDB-T Digital TV Signals,” by James J. Spilker, filed Nov. 8, 2002; the disclosures thereof incorporated by reference herein in their entirety.

Suitable components within analog television signals, such as the National Television System Committee (NTSC), Phase Alternating Line (PAL), and Sequential Color with Memory (SECAM) signals, include the horizontal synchronization pulse, the horizontal blanking pulse, the horizontal blanking pulse and horizontal synchronization pulse taken together, the ghost canceling reference signal, the vertical interval test signal, and other chirp-type signals such as multiburst signals, as described in copending U.S. Non-provisional Patent Applications Ser. No. 10/054,302, “Position Location using Broadcast Analog Television Signals,” by James J. Spilker and Matthew Rabinowitz, filed Jan. 22, 2002; and Ser. No. 10/159,831, “Position Location Using Ghost Canceling Reference Television Signals,” by James J. Spilker and Matthew Rabinowitz, filed May 31, 2002, the disclosures thereof incorporated by reference herein in their entirety.

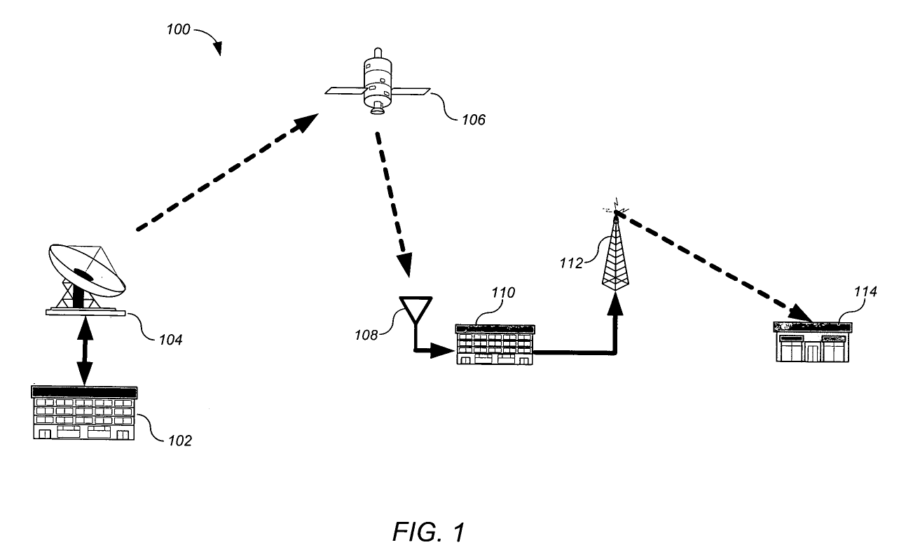

FIG. 1 shows a precision time transfer system 100 according to a preferred embodiment. Precision time transfer system 100 comprises a GPS control segment 102 having a GPS control segment antenna 104, a GPS satellite 106, a television station 108 having a GPS antenna 110 and a television antenna 112, and one or more telecommunication switches 114 each having a television antenna 116. While embodiments of the present invention are described with reference to the GPS satellite system, it will be apparent to one skilled in the relevant arts after reading this description that embodiments of the present invention can function with other satellite system having similar capabilities.

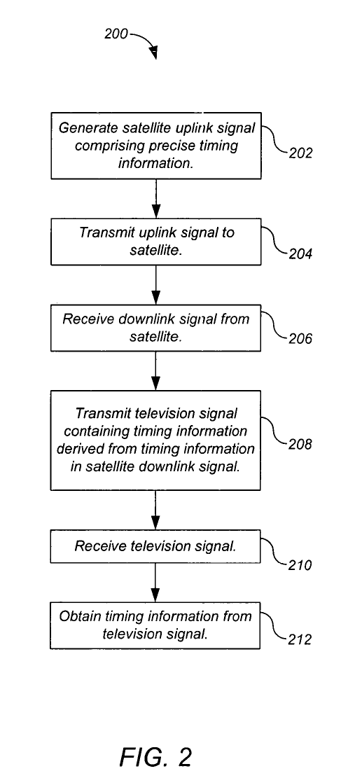

FIG. 2 shows a process 200 that can be performed by precision time transfer system 100 according to a preferred embodiment. GPS control segment 102 generates a GPS uplink signal comprising timing information derived from a master clock such as the U.S. Naval Observatory master clock (step 202). GPS control segment antenna 104 transmits the uplink signal to GPS satellite 106 (step 204). GPS satellite 106 transmits a downlink signal comprising the timing information. The GPS satellite clock is locked with a “paper clock” correction generated by the GPS control segment, as described in Global Positioning System: Theory and Applications,“by Bradford W. Parkinson and James J. Spilker, Jr., American Institute of Aeronautics and Astronautics, Inc., 1996. The GPS satellite rubidium or cesium clock is not corrected, but rather a “paper clock” correction is made that is transmitted as a quadratic in the GPS 50bps downlink data stream.

Television station 108 receives the downlink signals over GPS antenna 110 (step 206). Television station 108 transmits a television signal that contains timing information derived from the timing information in the GPS downlink signals (step 208). Telecommunication switch 114 receives the television signal over television antenna 116 (step 210) and obtains the timing information from the television signal (step 212). Telecommunication switch 114 can use the timing information, for example to accurately clock high-speed synchronous data transmission equipment. Of course, while embodiments of the present invention are described with reference to telecommunication switches as users, it will be apparent to one skilled in the relevant arts after reading this description that other sorts of users can receive and obtain the timing information in the television signals for other purposes.

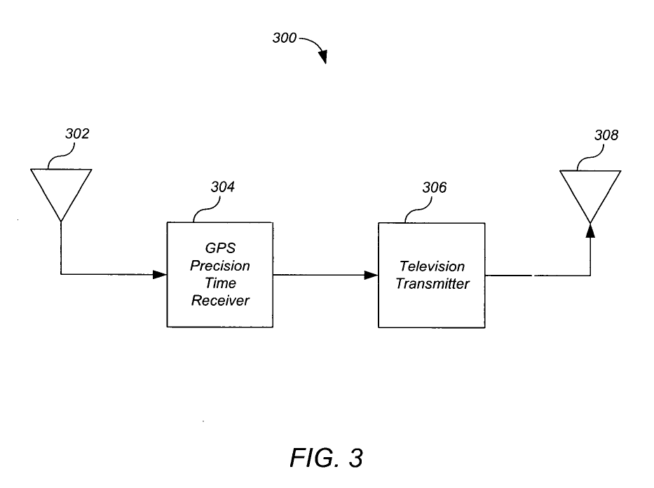

FIG. 3 is a block diagram of a television station 300 that can act as television station 108 of FIG. 1. Television station 300 comprises a GPS antenna 302, a GPS precision time receiver 304, a television transmitter 306, and a television antenna 308, all of which are commercially available.

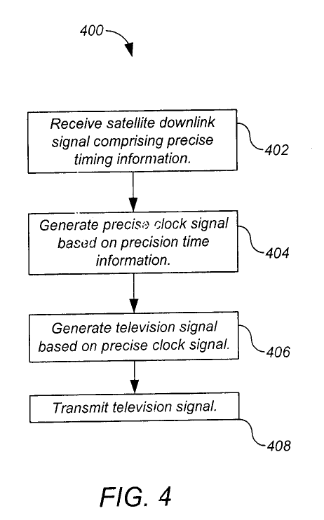

FIG. 4 shows a process 400 that can be executed by television station 300 according to a preferred embodiment. GPS precision time receiver 304 receives a GPS downlink signal comprising precise time information over GPS antenna 302 (step 402), and generates a precise clock signal based on the precision time information (step 404). Television transmitter 306 generates a television signal based on the precise clock signal (step 406), and transmits the television signal over television antenna 308 (step 408). The television signal contains a synchronization signal based on the precision time information in the received GPS signal. According to one embodiment, precise clock signal is used as the master symbol rate clock for television transmitter 306.

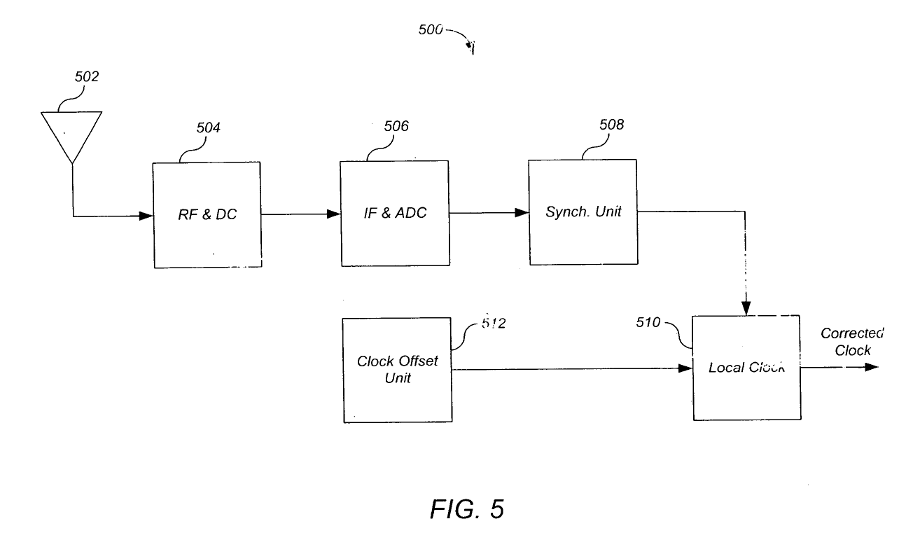

FIG. 5 is a block diagram of a television timing receiver 500 that can provide a precise clock signal, for example within telecommunication switches 114 of FIG. 1. Receiver 500 comprises a television antenna 502, a front end comprising a radio frequency (RF) filter and down converter 504 and an intermediate frequency (IF) downconverter and analog-to-digital converter (ADC) 506, a synchronization unit 508, a local clock 510, and a clock offset unit 512.

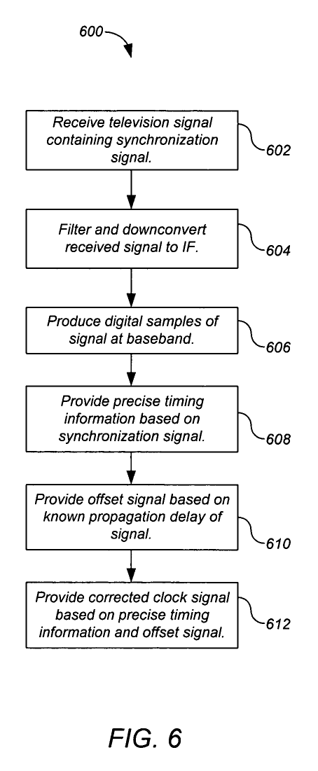

FIG. 6 shows a process that can be performed by receiver 500 according to a preferred embodiment. Receiver 500 receives the television signal containing the synchronization signal over television antenna 502 (step 602). RF filter and down converter 504, which is tuned to the frequency of the television signal to be received, filters and downconverts the received signal to IF (step 604). IF and ADC 506 produces digital samples of the signal at baseband (step 606).

Synchronization unit 508 provides precise timing information based on the synchronization signal contained in the television signals, as represented by the digital samples provided by IF and ADC 506 (step 608). Synchronization unit 508 can be implemented as a delay lock loop, a time-gated delay lock loop, a correlator, or the like.

Clock offset unit 512 provides an offset signal based on a known propagation delay between receiver 500 and the transmitter of the received television signal (step 610). The propagation delay can be computed using surveyed locations of the television transmitter antenna phase center and the location of antenna 502 of receiver 500. Alternatively, the system can be initially calibrated by carrying a cesium standard clock to receiver 500 and simply differencing the cesium standard clock and the timing information in the received television signal. Multipath delays are properly accounted in this calculation because the bulk of the multipath offset is fixed in time. If greater accuracy is required, clock offset unit 512 can correct for tropospheric delay using simple thermometer and atmospheric pressure gauges. The relationship between these parameters and delay is shown in chapter 13 of Global Positioning System: Theory and Applications, “by Bradford W. Parkinson and James J. Spilker, Jr., American Institute of Aeronautics and Astronautics, Inc., 1996.

Local clock 510 provides one or more corrected clock signals in accordance with the precise timing information provided by synchronization unit 508 and the offset signal provided by clock offset unit 512 (step 612). These corrected clock signals can be used to drive equipment requiring a very precise time reference, such as high-speed telecommunications equipment.

One advantage of this system over a separate GPS time transfer system lies in its simplicity. At a time when telecommunication systems are being forced to be very competitive and cost-effective, the use of a simple television timing receivers at each of the user terminals is important. The more complex GPS computations and clock setting are then left to the common television transmitter site, and are not required to be duplicated at each of the many television timing receivers. It is estimated that the television timing receivers cost can be a few hundred to a thousand dollars instead of the tens of thousands of dollars now required for precision GPS timing systems. The system is extremely simple and low-cost yet is capable of providing precision time down to the ten-nanosecond level to users around the world where there is at least one television station in view.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
a front end adapted to receive a television signal comprising a synchronization signal representing precise timing information derived from a satellite signal; and
a synchronization unit adapted to obtain the precise timing information from the television signal, and further adapted to provide a clock correction signal based on the precise timing information.

2. The apparatus of claim 1:
wherein the satellite is a global positioning system satellite

3. The apparatus of claim 1, further comprising:
a local clock adapted to generate a precise clock signal based on the clock correction signal provided by the synchronization unit.

4. The apparatus of claim 3, further comprising:
an antenna adapted to receive the television signal from a transmitter of the television signal, and further adapted to provide the television signal to the front end; and
a clock offset unit adapted to provide an offset signal based on a propagation delay between the transmitter of the television signal and the antenna;
wherein the local clock is further adapted to generate the precise clock signal based on the offset signal provided by the clock offset unit.

5. The apparatus of claim 4, wherein:
the clock offset unit is further adapted to provide the offset signal based on a tropospheric propagation velocity in the vicinity of the antenna.

6. A telecommunication switch comprising the apparatus of claim 1.

7. The apparatus of claim 1, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

8. An apparatus comprising:
front end means for receiving a television signal comprising a synchronization signal representing precise timing information derived from a satellite signal; and
synchronization means for obtaining the precise timing information from the television signal, and further adapted to provide a clock correction signal based on the precise timing information.

9. The apparatus of claim 8:
wherein the satellite is a global positioning system satellite

10. The apparatus of claim 8, further comprising:
local clock means for generating a precise clock signal based on the clock correction signal provided by the synchronization means.

11. The apparatus of claim 10, further comprising:
antenna means for receiving the television signal from a transmitter of the television signal, and further adapted to provide the television signal to the front end; and
clock offset means for providing an offset signal based on a propagation delay between the transmitter of the television signal and the antenna means;
wherein the local clock means generates the precise clock signal based on the offset signal provided by the clock offset means.

12. The apparatus of claim 11, wherein:
the clock offset means provides the offset signal based on a tropospheric propagation velocity in the vicinity of the antenna means.

13. A telecommunication switch comprising the apparatus of claim 8.

14. The apparatus of claim 8, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

15. A method comprising:
receiving a television signal comprising a synchronization signal representing precise timing information derived from a satellite signal;
obtaining the precise timing information from the television signal; and
providing a clock correction signal based on the precise timing information.

16. The method of claim 15, wherein:
the satellite is a global positioning system satellite

17. The method of claim 15, further comprising:
generating a precise clock signal based on the clock correction signal provided by the synchronization unit.

18. The method of claim 15, further comprising:
determining a propagation delay between a transmitter of the television signal and an antenna that receives the television signal; and
providing the clock correction signal based on the precise timing information and the propagation delay.

19. The method of claim 18, wherein determining the propagation delay comprises:
determining a tropospheric propagation velocity in the vicinity of the antenna.

20. The method of claim 15, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

21. Computer-readable media embodying instructions executable by a computer to perform a method comprising:
receiving a television signal comprising a synchronization signal representing precise timing information derived from a satellite signal;
obtaining the precise timing information from the television signal; and
providing a clock correction signal based on the precise timing information.

22. The media of claim 21, wherein:
the satellite is a global positioning system satellite

23. The media of claim 21, wherein the method further comprises:
generating a precise clock signal based on the clock correction signal provided by the synchronization unit.

24. The media of claim 21, wherein the method further comprises:
determining a propagation delay between a transmitter of the television signal and an antenna that receives the television signal; and
providing the clock correction signal based on the precise timing information and the propagation delay.

25. The media of claim 24, wherein determining the propagation delay comprises:
determining a tropospheric propagation velocity in the vicinity of the antenna.

26. The media of claim 21, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

27. An apparatus comprising:
a satellite time receiver adapted to receive a satellite signal from a satellite, the satellite signal comprising precise timing information; and
a television transmitter adapted to generate a television signal comprising a synchronization signal based on the precise timing information, and further adapted to transmit the television signal.

28. The apparatus of claim 27:
wherein the satellite is a global positioning system satellite.

29. The apparatus of claim 27, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

30. An apparatus comprising:
satellite time receiver means for receiving a satellite signal from a satellite, the satellite signal comprising precise timing information; and
television transmitter means for generating a television signal comprising a synchronization signal based on the precise timing information, and for transmitting the television signal.

31. The apparatus of claim 30:
wherein the satellite is a global positioning system satellite.

32. The apparatus of claim 30, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

33. A method comprising:
receiving a satellite signal from a satellite, the satellite signal comprising precise timing information;
generating a television signal comprising a synchronization signal based on the precise timing information; and
transmitting the television signal.

34. The method of claim 33:
wherein the satellite is a global positioning system satellite.

35. The method of claim 33, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.

36. Computer-readable media embodying instructions executable by a computer to perform a method comprising:
receiving a satellite signal from a satellite, the satellite signal comprising precise timing information;
generating a television signal comprising a synchronization signal based on the precise timing information; and
transmitting the television signal.

37. The media of claim 36:
wherein the satellite is a global positioning system satellite.

38. The media of claim 36, wherein the television signal is selected from the group comprising:
an American Television Standards Committee (ATSC) digital television signal;
an Integrated Services Digital Broadcasting-Terrestrial (ISDB-T) signal;
a European Telecommunications Standards Institute (ETSI) Digital Video Broadcasting-Terrestrial (DVB-T) signal; and
a National Television System Committee (NTSC), Phase Alternating Line (PAL), or Sequential Color with Memory (SECAM) analog television signal.
